(19) United States
(12) Patent Application Publication
(10) Pub. No.: US 2021/0203890 A1
(43) Pub. Date: Jul. 1, 2021

(54) APPARATUS FOR MONITORING SURROUNDING OF VEHICLE

(71) Applicant: SL Mirrortech Corporation, Siheung-si (KR)

(72) Inventors: Minsu BAE, Siheung-si (KR); Jaehyun CHOI, Siheung-si (KR); Changju KIM, Siheung-si (KR); Hyunkug HONG, Siheung-si (KR); Seokjun JANG, Siheung-si (KR); Jinsan KIM, Siheung-si (KR); Jungyeol YE, Siheung-si (KR); Seokkeon KWON, Siheung-si (KR); Minhee LEE, Siheung-si (KR); Jihwan MOON, Siheung-si (KR); Suyoung CHOI, Siheung-si (KR); Youngnam SHIN, Siheung-si (KR)

(21) Appl. No.: 17/129,419

(22) Filed: Dec. 21, 2020

(30) Foreign Application Priority Data
Dec. 26, 2019 (KR) 10-2019-0175540

(51) Int. Cl. H04N 7/18; H04N 5/272; G09G 5/38; B60R 1/00

(52) U.S. Cl. CPC H04N 7/183; H04N 5/272; G09G 5/38; B60R 1/00; B60R 2300/8046; G09G 2380/10; B60R 2300/30; B60R 2300/20; G09G 2354/00

(57) ABSTRACT

An apparatus for monitoring surroundings of a vehicle provides images around the vehicle to allow a driver to more easily monitor the surroundings of the vehicle. The apparatus for monitoring surroundings of a vehicle includes an imaging device that acquires an original image for at least one direction around the vehicle; an image processor configured to extract a monitoring image corresponding to a set area in the original image; and an image display that outputs the extracted monitoring image. The image processor is configured to display a guide map that indicates a relative positional relationship between the original image and the monitoring image on the monitoring image.

### CROSS-REFERENCE TO RELATED APPLICATION

This application claims priority from Korean Patent Application No. 10-2019-0175540 filed on Dec. 26, 2019, which application is herein incorporated by reference in its entirety.

### BACKGROUND

### 1. Technical Field

The present disclosure relates to an apparatus for monitoring surroundings of a vehicle, and more specifically, to an apparatus for monitoring surroundings of a vehicle in which it provides images around the vehicle to allow a driver to more easily monitor the surroundings of the vehicle.

### 2. Description of the Related Art

Generally, in a vehicle, inside mirrors allow a driver to secure a rear view of the vehicle, and outside mirrors are installed on both sides of the vehicle. The driver perceives surrounding vehicles or pedestrians in situations such as reversing the vehicle, passing, or changing lanes based on the view acquired with the inside mirror or the outside mirror.

Recently, cameras are installed in a vehicle instead of outside mirrors to reduce aerodynamic drag and reduce the possibility of damage caused by external impacts when the vehicle is operating. An image acquired by the camera is displayed through a display device provided inside the vehicle. Accordingly, a driver may easily perceive surrounding situations of the vehicle.

Generally, an image is displayed via a display device by extracting a portion of an image acquired by a camera. A driver secures an optimal field of view by adjusting an extracted area among the images acquired by the camera. However, it is not possible to perceive a relative positional relationship between the image acquired by the camera and the extracted area. Therefore, it is required to repeatedly adjust the extracted area until a desired area is extracted.

Accordingly, there is a need for a method that enables a driver to easily perceive the relative positional relationship between an image acquired by a camera and an area to be extracted.

### SUMMARY

Aspects of the present disclosure provide an apparatus for monitoring surroundings of a vehicle, which enables a driver to more easily perceive a relative positional relationship between an image acquired by an imaging device and an area to be extracted.

Problems of the present disclosure are not limited to the above-mentioned problem, and other problems not mentioned may be clearly understood by a person skilled in the art from the following description.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, an apparatus for monitoring surroundings of a vehicle may include an imaging device that acquires an original image for at least one direction around the vehicle; an image processor configured to extract a monitoring image corresponding to a set area in the original image; and an image display that outputs the extracted monitoring image. The image processor may be configured to display a guide map that indicates a relative positional relationship between the original image and the monitoring image on the monitoring image.

The guide map may comprise a first display area corresponding to the original image, and a second display area corresponding to the monitoring image, and the image processor may be configured to cause the second display area to be moved and displayed within the first display area in accordance with a position of the set area.

The first display area may comprise a line representing a vehicle body line.

The image processor may be configured to display a captured image of the original image in the first display area when the position of the set area is adjusted. The captured image may be the original image that is captured at the time when the guide map is activated.

Alternatively, the image processor may be configured to output the original image in the first display area. Further, the image processor may be configured to display an angle of view of at least one of a horizontal direction or a vertical direction in the guide map.

The first display area and the second display area may have different image properties. The image properties may comprise at least one of hue, saturation, brightness, or transparency of image.

A user interface may be further provided for adjusting a position of the set area, and the image processor may be configured to display the guide map on the monitoring image in response to an operation signal being input from the operation unit. Further, the image processor may be configured to remove the guide map from the monitoring image when no operation signal is input for a predetermined period of time or longer.

Another aspect of the present disclosure provides a non-transitory computer readable medium containing program instructions executed by a processor or controller. The program instructions, when executed by the processor or controller, may be configured to acquire, using an imaging device, an original image for at least one direction around a vehicle; display, in an image display, a monitoring image that is extracted from the original image to correspond to a set area within the original image; and display, in the image display, a guide map that indicates a relative positional relationship between the original image and the monitoring image.

The guide map may comprise a first display area that shows the original image, and a second display area that shows the monitoring image, and the program instructions may be configured to allow the second display area to be moved and displayed within the first display area in accordance with a position of the set area relative to the original image.

The program instructions may be configured to display the guide map on the monitoring image in response to receiving an operation signal via a user interface. The program instructions may be configured to remove the guide map from the monitoring image when no operation signal is input for a predetermined period of time or longer. Further, the program instructions may be configured to display a captured image of the original image in the first display area when the position of the set area is adjusted, the captured image being the original image at a time when the guide map is activated.

The program instructions may be further configure to display, in the first display area, a line that represents a vehicle body line. The program instructions may be configured to display an angle of view of at least one of a horizontal direction or a vertical direction in the guide map.

The first display area and the second display area may have different image properties, which comprise at least one of hue, saturation, brightness, or transparency of image.

An apparatus for monitoring surroundings of a vehicle according to the present disclosure has one or more of the following benefits. A driver's convenience may be improved by displaying a relative positional relationship between an original image and a set area based on a position of the set area corresponding to a monitoring image in the original image that is acquired by an imaging device.

The benefits of the present disclosure are not limited to the above-mentioned benefits, and other benefits not mentioned may be clearly understood by a person skilled in the art from the claims.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram showing an apparatus for monitoring surroundings of a vehicle according to an exemplary embodiment of the present disclosure;

FIG. 2 is a schematic diagram showing a vehicle in which an image acquisition unit is installed according to an exemplary embodiment of the present disclosure;

FIG. 3 is a schematic view showing a horizontal angle of view of an image acquisition unit according to an exemplary embodiment of the present disclosure;

FIG. 4 is a schematic diagram showing a vertical angle of view of an image acquisition unit according to an exemplary embodiment of the present disclosure;

FIG. 5 is a schematic diagram showing a set area corresponding to a monitoring image according to an exemplary embodiment of the present disclosure;

FIG. 6 is a schematic diagram showing an extraction angle in a horizontal direction of a set area according to an exemplary embodiment of the present disclosure;

FIG. 7 is a schematic diagram showing an extraction angle in a vertical direction of a set area according to an exemplary embodiment of the present disclosure;

FIG. 8 is a schematic diagram showing a position of an image output unit according to an exemplary embodiment of the present disclosure;

FIG. 9 is a schematic diagram showing a position of a set area in an original image according to an exemplary embodiment of the present disclosure;

FIG. 10 is a schematic diagram showing a guide map according to an exemplary embodiment of the present disclosure;

FIG. 11 is a schematic diagram showing a second display area in which a position is moved within a first display area according to an exemplary embodiment of the present disclosure; and

FIGS. 12 to 15 are schematic diagrams showing a guide map according to another exemplary embodiment of the present disclosure.

### DETAILED DESCRIPTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the disclosure to those skilled in the art, and the present disclosure will only be defined by the appended claims. Throughout the specification, like reference numerals in the drawings denote like elements.

In some exemplary embodiments, well-known steps, structures and techniques will not be described in detail to avoid obscuring the disclosure.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the disclosure are described herein with reference to plan and cross-section illustrations that are schematic illustrations of idealized exemplary embodiments of the disclosure. As such, variations from the shapes of the illustrations as a result, for example, of manufacturing techniques and/or tolerances, are to be expected. Thus, exemplary embodiments of the disclosure should not be construed as limited to the particular shapes of regions illustrated herein but are to include deviations in shapes that result, for example, from manufacturing. In the drawings, respective components may be enlarged or reduced in size for convenience of explanation.

Hereinafter, the present disclosure will be described with reference to the drawings for an apparatus for monitoring surroundings of a vehicle according to exemplary embodiments of the present disclosure.

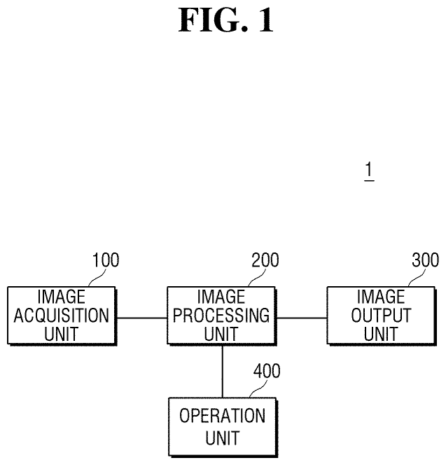

FIG. 1 is a block diagram showing an apparatus for monitoring surroundings of a vehicle according to an exemplary embodiment of the present disclosure. Referring to FIG. 1, a surrounding monitoring system 1 of a vehicle according to an exemplary embodiment of the present disclosure may include an image acquisition unit 100 (e.g., an imaging device), an image processor 200, an image output unit 300 (e.g., an image display), and an operation unit 400.

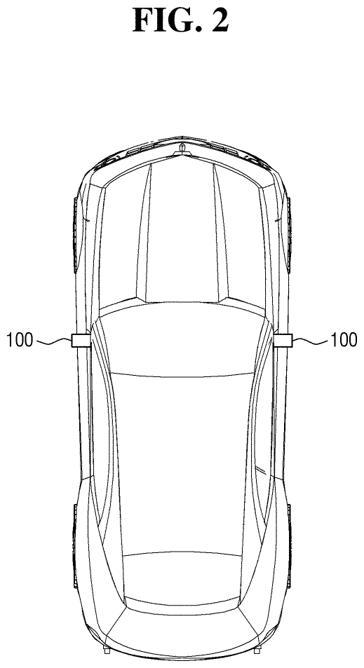

In an exemplary embodiment of the present disclosure, the image acquisition unit 100 may be installed on or near the front doors of both sides of the vehicle as shown in FIG. 2 to allow the surrounding monitoring system 1 of the vehicle according to the present disclosure to replace a role of an exterior mirror, and to acquire an image of the rear and/or lateral rear of the vehicle. However, the present disclosure is not limited thereto, and the image acquisition unit 100 may acquire an image of at least one direction in which a driver's monitoring or attention is required.

In an exemplary embodiment of the present disclosure, the image acquisition unit 100 installed on the driver side among both sides of the vehicle will be described as an example. The image acquisition unit 100 installed on the passenger side (i.e., the opposite side of the driver side) may also be similarly configured, although there may be some differences in terms of installation positions. Herein, the driver side and the passenger side respectively refer to a side where the driver of the vehicle seats and a side that is opposite from the driver side. In the United States, the left side of the vehicle is typically referred to as the driver side, and the right side of the vehicle is typically referred to as the passenger side. However, the actual sides of the driver side and the passenger side in terms of the left-right direction may vary depending on the road-use customs and local regulations and stipulations.

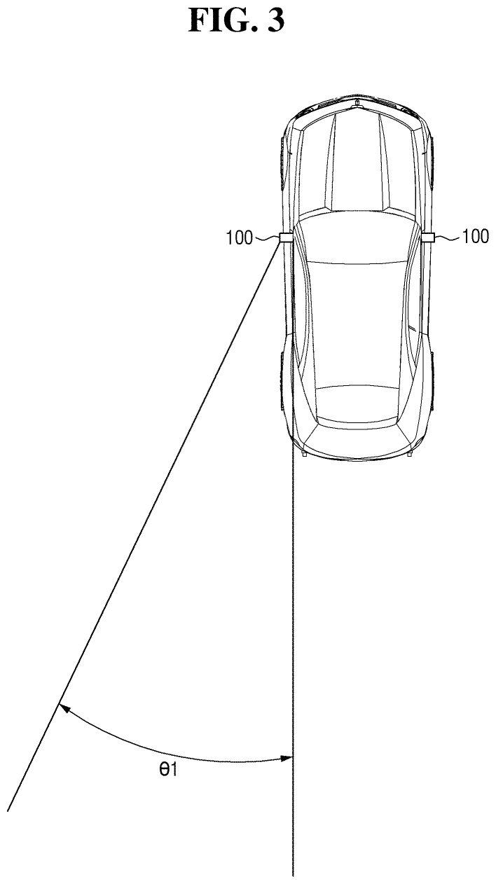

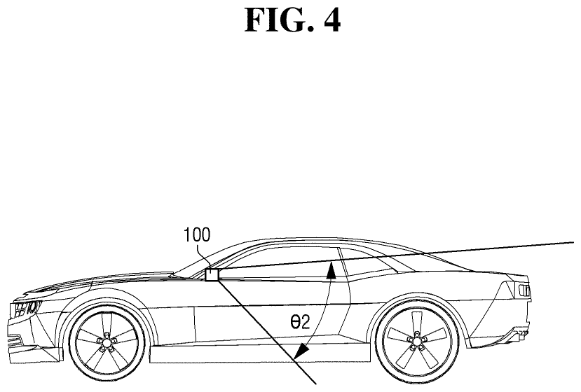

The image acquisition unit 100 may use at least one imaging device (e.g. a camera) having various angles of view (e.g., viewing angle, field of view, or the like), such as a narrow-angle camera or a wide-angle camera, depending on a field of view that the driver needs to monitor. In an exemplary embodiment of the present disclosure, the image acquisition unit 100 may acquire an image exhibiting an angle of view of θ1 in the horizontal direction as shown in FIG. 3 and an angle of view of θ2 in the vertical direction as shown in FIG. 4.

A size of the image acquired by the image acquisition unit 100 may be defined by the angle of view θ1 in the horizontal direction and the angle of view θ2 in the vertical direction. Hereinafter, the image acquired by the image acquisition unit 100 in an exemplary embodiment of the present disclosure will be referred to as an “original image.”

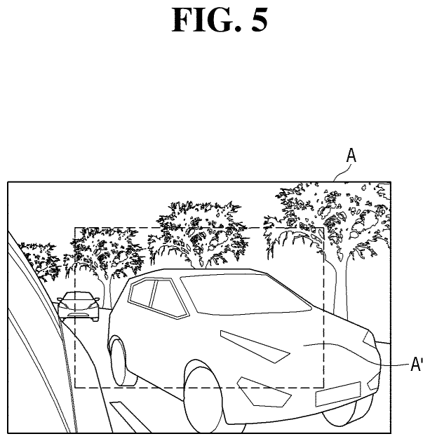

The image processor 200 may be configured to extract a monitoring image corresponding to a set area A′ of the original image A as shown in FIG. 5, and cause the extracted monitoring image to be output via the image output unit 300. The set area A′ may be determined based on a size of objects such as surrounding vehicles, pedestrians, and stationary facilities included in the monitoring image. The size of the set area A′ may be determined to have a magnification that reduces a risk that the driver may misunderstand the size of and/or the distance to the object appearing in the monitoring image.

In other words, as the set area A′ increases, the size of the object appearing in the monitoring image decreases and thus the magnification decreases. Therefore, the smaller the set area A′ is, the larger the size of the object appearing in the monitoring image becomes, and thus the magnification increases. The set area A′ may be determined to have a magnification that allows the driver to appropriately recognize the size of the object appearing in the monitoring image or the distance to the object.

The original image A may have a larger size than the set area A′. In other words, the set area A′ may be set to a portion of the original image A. This is to prevent image distortion in the monitoring image because the image distortion is more likely to occur in an edge region of the original image A than in a central region thereof, and to allow the set area A′ to be adjusted according to the driver's preference.

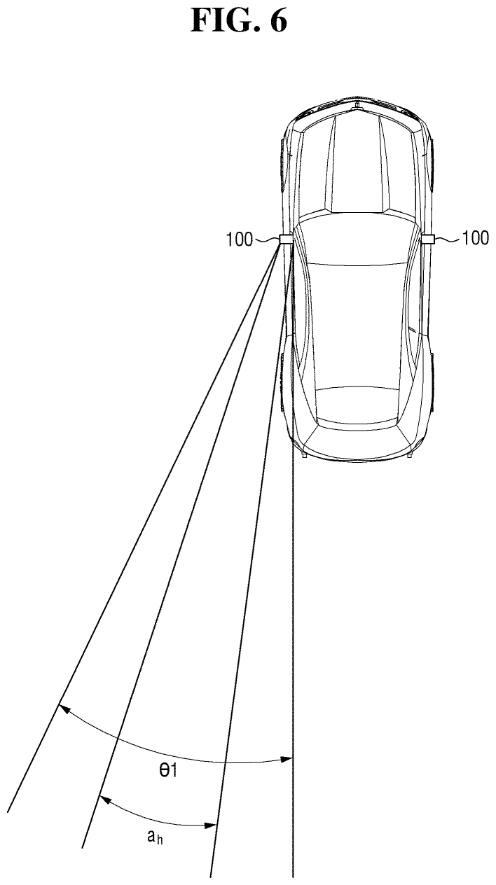

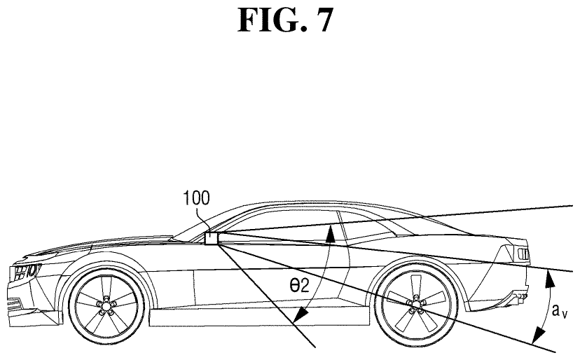

The set area A′ may be defined with respect to an extraction angle aₕ in the horizontal direction and an extraction angle aᵥ in the vertical direction as shown in FIGS. 6 and 7. The size of the set area A′ may be determined based on the extraction angle aₕ in the horizontal direction and the extraction angle aᵥ in the vertical direction. In other words, as at least one of the extraction angle aₕ in the horizontal direction or the extraction angle aᵥ in the vertical direction increases, the size of the set area A′ may be increased in the at least one of the horizontal direction or the vertical direction. As at least one of the extraction angle aₕ in the horizontal direction or the extraction angle aᵥ in the vertical direction decreases, the size of the set area A′ may be decreased in the at least one of the horizontal direction or the vertical direction.

Herein, the extraction angle aₕ in the horizontal direction and the extraction angle aᵥ in the vertical direction may be determined to provide a required magnification based on a distance or angle between the image output unit 300 and the driver's view point (e.g., a location of the driver's eyes).

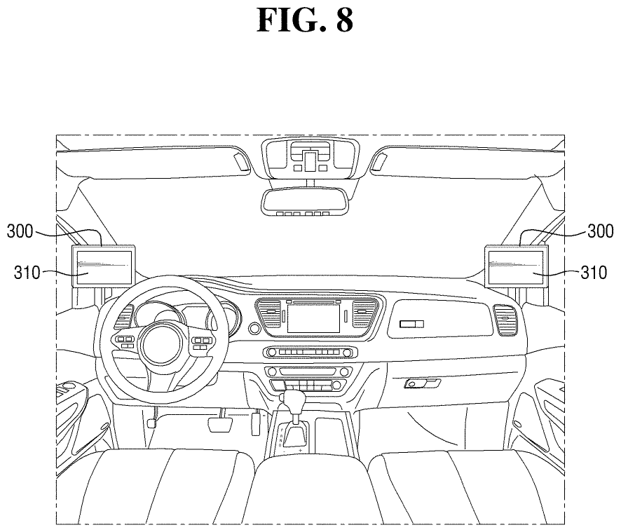

The image output unit 300 may include an image display 310 (e.g., a screen) having a predetermined size on which the monitoring image is output or displayed. In an exemplary embodiment of the present disclosure, the image acquisition units 100 may be installed on both sides of the vehicle, respectively. Therefore, as shown in FIG. 8, the image output units 300 may also be installed on the driver side and the passenger side, respectively. For example, the image output units 300 may be installed in the vicinity of A-pillars on both sides of a dashboard.

The operation unit 400 may allow the driver to activate a guide map for adjusting a position of the set area A′, and may enable the driver to adjust the position of the set area A′. The operation unit 400 may include a user-interface and may be provided in the vehicle in the form of a button, switch, joystick, or the like. However, the present disclosure is not limited thereto, and when the image output unit 300 is configured as a touch display panel, the operation unit 400 may be provided as a touch button. In such exemplary embodiments, the image display and the user-interface may be provided as a single unit such as a touch screen.

For example, when the driver wants to increase the view toward the lateral sideways of the vehicle in the monitoring image that is being currently output via the image output unit 300 or to reduce a proportion of the vehicle's own body in the monitoring image, the guide map may be called or activated via the operation unit 400 to allow the guide map to be displayed, and then the position of the set area A′ in the original image A may be adjusted.

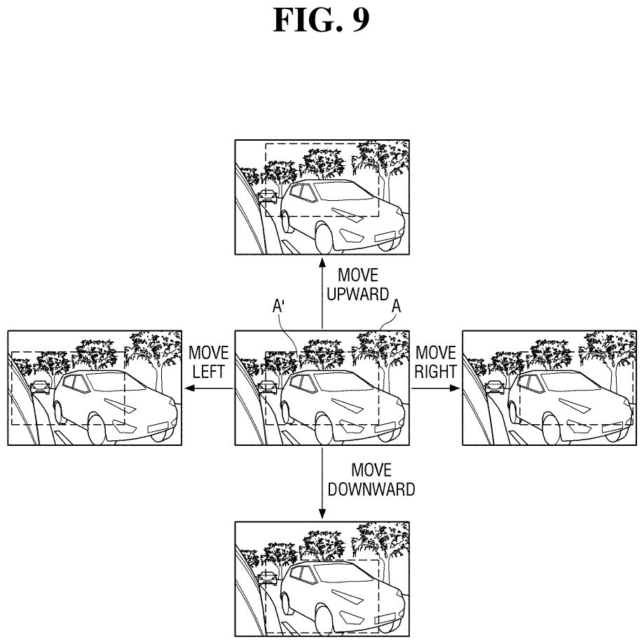

FIG. 9 is a schematic diagram showing a set area in which a position is adjusted by an operation unit according to an exemplary embodiment of the present disclosure. Referring to FIG. 9, the driver may activate the guide map to allow the guide map to be displayed for adjusting the position of the set area A′ according to the driver's preference. Subsequently, the driver may move the position of the set area A′ in the up, down, left, and right directions using the operation unit 400 based on the set area A′ as shown in FIG. 5 and described above. The image processor 200 may be configured to extract a monitoring image corresponding to the set area A′, which is moved by the driver, from the original image A. In FIG. 9, the position of the set area A′ may be moved in the up, down, left, and right directions. However, the present disclosure is not limited thereto, and the set area A′ may be moved in a diagonal direction, which is a combination of two or more directions.

As described above, when the driver adjusts the position of the set area A′ using the operation unit 400, it may be difficult for the driver to perceive a relative position of the set area A′ with respect to the actual original image A. Therefore, it may be possible for the driver to attempt to adjust the position of the set area A′ even when an edge of the set area A′ is disposed on an edge of the original image A and further positioning of the set area A′ is no longer possible. In such a circumstance, unnecessary operation may occur, thereby reducing the driver's convenience.

In other words, when the driver is unaware of the relative positional relationship between the original image A and the set area A′, unnecessary operation may be frequently input by the driver even though the position of the set area A′ is unable to be adjusted further. To this end, in an exemplary embodiment of the present disclosure, information that allows the driver to know the relative positional relationship between the original image A and the set area A′ may be displayed on the monitoring image, thereby facilitating the driver's convenience.

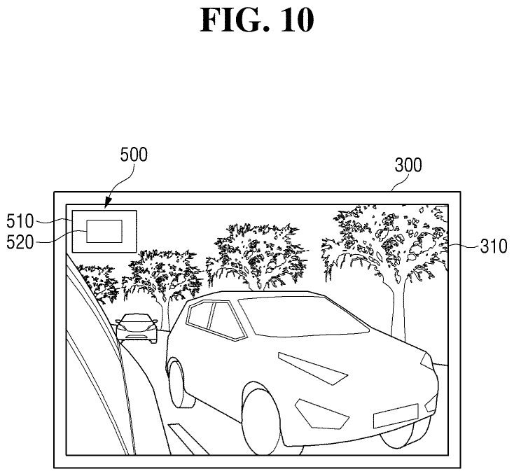

FIG. 10 is a schematic diagram showing a guide map displayed on a monitoring image according to an exemplary embodiment of the present disclosure. Referring to FIG. 10, in response to the guide map being activated by the driver, the image processor 200 may be configured to display a guide map 500 on the monitoring image that is displayed on the image output unit 300. The guide map 500 may indicate a position of the set area A′, which corresponds to the monitoring image, within the original image A.

In an exemplary embodiment of the present disclosure, the image processor 200 may be configured to synthesize the guide map 500 with the monitoring image, e.g., by inserting the guide map 500 within the monitoring image, when an operation signal is input by the operation unit 400, and may be configured to display no guide map when no operation signal is input for a certain period of time or longer. However, the present disclosure is not limited thereto, and the guide map 500 may be displayed even when no operation signal is input.

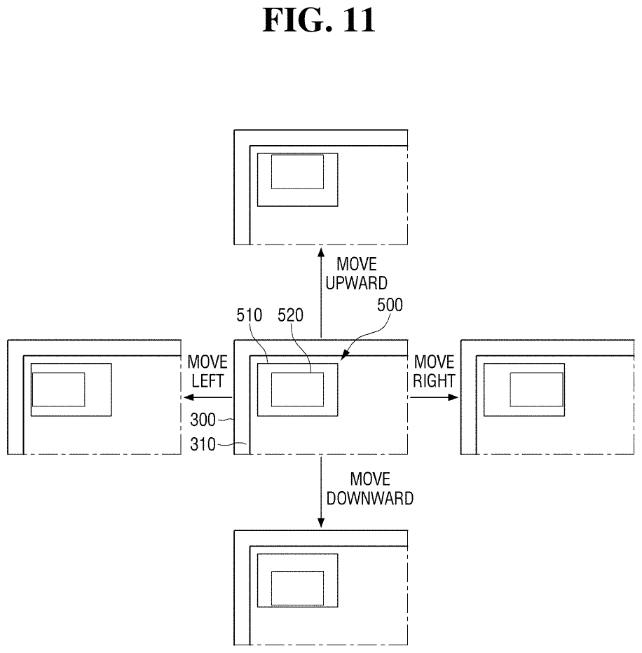

The guide map 500 may include a first display area 510 that shows the original image A and a second display area 520 that shows the set area A′, which corresponds to the monitoring image. As shown in FIG. 11, the second display area 520 may be moved to a position corresponding to the set area A′ within the first display area 510 as the driver operates the operation unit 400, and the monitoring image that is displayed on the screen 310 having a predetermined size may also be moved in accordance with the movement of the first display area 510.

FIG. 11 shows an example in which, as shown in FIG. 9, when the set area A′ is moved in the up, down, left, and right directions, the second display area 520 is moved in the up, down, left, and right directions within the first display area 510. However, the present disclosure is not limited thereto, and the second display area 520 may be moved in the diagonal directions as well as in the up, down, left, and right directions depending on a moving direction of the set area A′.

The first display area 510 and the second display area 520 may have different image properties, for example, hue, saturation, brightness, transparency, and the like to secure driver's visibility. By way of examples, the first display area 510 may be displayed in black and white image (i.e., substantially reduced saturation), and the second display area 520 may be displayed in color. The driver may adjust the position of the set area A′ by operating the operation unit 400 while checking the position of the set area A′ based on the original image A through the guide map 500. By way of examples, the second display area 520 may be moved within the first display area 510 by touch-dragging on the screen 310 or by manipulating a joystick-type switch that is separately provided, e.g., at the center fascia, at the dashboard, or adjacent to a power-windows switch on a door-panel. The present disclosure is not limited thereto, however, and the user-interface for the operation unit 400 may be variously configured.

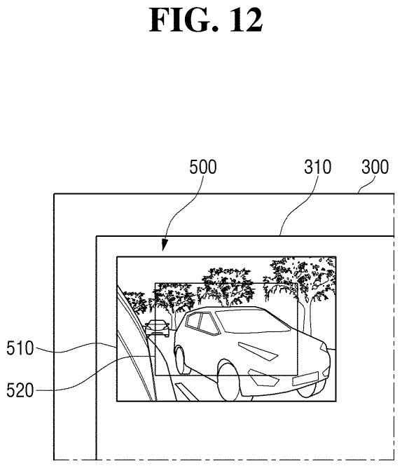

In the exemplary embodiment described above, an example has been described in which the first display area 510 and the second display area 520 have different image properties. However, the present disclosure is not limited thereto, and as shown in FIG. 12, an image of the original image A that is captured at the time when the driver operates the operation unit 400 may be displayed on the first display area 510 such that the driver may more intuitively recognize a position of the second display area 520.

Therefore, the driver may check the proportion occupied by the vehicle body in the set area A′, and the operation unit 400 may be operated to increase or decrease the proportion occupied by the vehicle body in the set area A′ according to the driver's preference, thereby adjusting the position of the second display area 520 as shown in FIG. 11 described above.

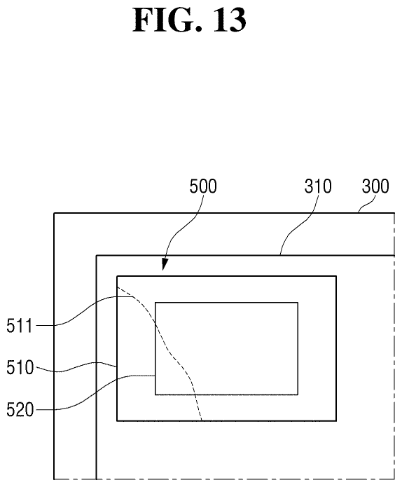

FIG. 12 shows an example in which the captured image is displayed on the first display area 510. However, the present disclosure is not limited thereto, and the original image A may be displayed as a picture in picture (PIP) image in the first display area 510 such that the position of the set area A′ may be adjusted while checking the original image A that changes in real time. In the exemplary embodiment described above, an example has been described in which the driver adjusts the position of the set area A′ while the driver checks a body line via the PIP image. However, the present disclosure is not limited thereto, and, as shown in FIG. 13, a line 511 that represents the vehicle body may be displayed on the first display area 510.

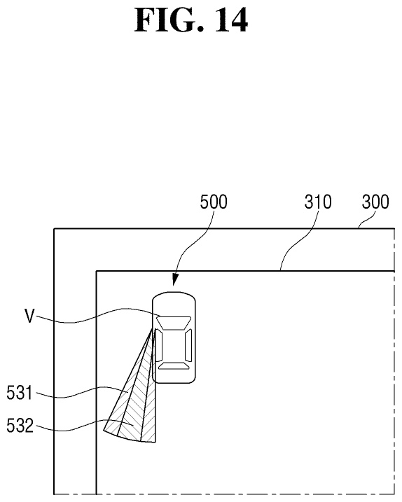

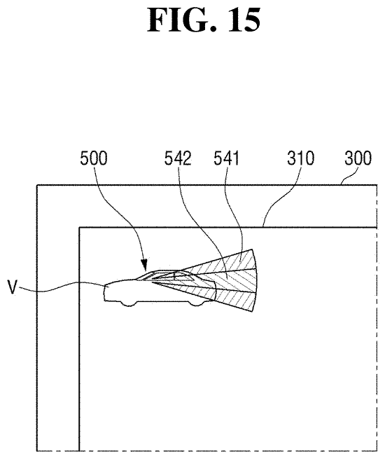

In the exemplary embodiment described above, an example has been described in which the relative positional relationship between the original area A and the set area A′ is displayed by the second display area 520, the position of which is moved within the first display area 510. However, the present disclosure is not limited thereto, and as shown in FIGS. 14 and 15, the guide map 500 may include a diagram representing a horizontal angle of view (e.g. a horizontal viewing angle) and/or a diagram representing a vertical angle of view (e.g., a vertical viewing angle).

For example, when the driver adjusts the position of the set area A′ in the horizontal direction using the operation unit 400, the guide map 500 may be displayed as a horizontal angle of view 532 of the set area A′ with respect to a horizontal angle of view 531 of the original image A as shown in FIG. 14. When the driver adjusts the position of the set area A′ in the vertical direction, the guide map 500 may be displayed as a vertical angle of view 542 of the set area A′ with respect to the vertical angle of view 541 of the original image A as shown in FIG. 15.

FIGS. 14 and 15 described above are examples in which the position of the set area A′ in the original image A that is acquired by the image acquisition unit 100 installed on the driver's seat side is adjusted. Although FIGS. 14 and 15 describe an example in which the guide map 500 is displayed on the driver side based on a vehicle icon V, the present disclosure is not limited thereto. When adjusting the position of the set area in the original image that is acquired by the image acquisition unit installed on the passenger side, the guide map 500 may be displayed on the passenger side based on the vehicle icon.

In addition, in FIGS. 14 and 15, an example has been described in which the guide maps 500 indicating the horizontal angle of view and the vertical angle of view are displayed respectively. However, the present disclosure is not limited thereto, and when the driver adjusts the position of the set area A′ in either the horizontal or vertical direction, the guide maps 500 indicating the horizontal angle of view and the vertical angle of view may be simultaneously displayed.

When the image output units 300 are respectively disposed on the left and right sides of the driver as shown in FIG. 8 described above, the image output unit on the passenger side may be disposed farther from the driver's eyes than the image output unit on the driver side. To compensate for the distance discrepancy, a size of the guide map of the image output unit on the passenger side may be larger than a size of the guide map of the image output unit on the driver side, which may allow the driver to more easily adjust the left and right images. In other words, the driver may select the image output unit of the driver side or the image output unit of the passenger side using the operation unit 400. When the driver selects the image output unit of the passenger side, the guide map may be displayed with a larger size than when the guide map is displayed on the image output unit of the driver side.

Although exemplary embodiment is described as using a plurality of units to perform the exemplary processes, it is understood that the exemplary processes may also be performed by one or plurality of modules. Additionally, it is understood that the term processor/image processor/controller/control unit refers to a hardware device that includes a memory and a processor. The memory is configured to store the modules and the processor is specifically configured to execute said modules to perform one or more processes which are described above.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

As described above, with the surrounding monitoring system 1 for sensing the surroundings of the vehicle according to the present disclosure, the driver may adjust the position of the set area A′ while checking the relative positional relationship between the original image A acquired by the image acquisition unit 100 and the set area A′ corresponding to the monitoring image being output via the image output unit 300 using the guide map 500. Accordingly, the driver's convenience may be improved.

In concluding the detailed description, those skilled in the art will appreciate that many variations and modifications can be made to the exemplary embodiments without substantially departing from the principles of the present disclosure. Therefore, the disclosed exemplary embodiments of the disclosure are used in a generic and descriptive sense only and not for purposes of limitation.

What is claimed is:

1. An apparatus for monitoring surroundings of a vehicle, comprising:
an imaging device that acquires an original image for at least one direction around the vehicle;
an image processor configured to extract a monitoring image corresponding to a set area in the original image; and
an image display that outputs the extracted monitoring image,
wherein the image processor is configured to display a guide map that indicates a relative positional relationship between the original image and the monitoring image on the monitoring image.

2. The apparatus of claim 1, wherein the guide map comprises a first display area corresponding to the original image, and a second display area corresponding to the monitoring image, and
wherein the image processor is configured to cause the second display area to be moved and displayed within the first display area in accordance with a position of the set area.

3. The apparatus of claim 2, wherein the first display area comprises a line representing a vehicle body line.

4. The apparatus of claim 2, wherein the image processor is configured to display a captured image of the original image in the first display area when the position of the set area is adjusted, the captured image being the original image at a time when the guide map is activated.

5. The apparatus of claim 2, wherein the image processor is configured to output the original image in the first display area.

6. The apparatus of claim 2, wherein the image processor is configured to display an angle of view of at least one of a horizontal direction or a vertical direction in the guide map.

7. The apparatus of claim 2, wherein the first display area and the second display area have different image properties.

8. The apparatus of claim 7, wherein the image properties comprise at least one of hue, saturation, brightness, or transparency of image.

9. The apparatus of claim 1, further comprising:
a user interface for adjusting a position of the set area,
wherein the image processor is configured to display the guide map on the monitoring image in response to an operation signal being input from the user interface.

10. The apparatus of claim 9, wherein the image processor is configured to remove the guide map from the monitoring image when no operation signal is input for a predetermined period of time or longer.

11. A non-transitory computer readable medium containing program instructions executed by a processor or controller, the program instructions when executed by the processor or controller configured to:
acquire, using an imaging device, an original image for at least one direction around a vehicle;
display, in an image display, a monitoring image that is extracted from the original image to correspond to a set area within the original image; and
display, in the image display, a guide map that indicates a relative positional relationship between the original image and the monitoring image.

12. The non-transitory computer readable medium of claim 11, wherein the guide map comprises a first display area that shows the original image, and a second display area that shows the monitoring image, and
wherein the program instructions are configured to allow the second display area to be moved and displayed within the first display area in accordance with a position of the set area relative to the original image.

13. The non-transitory computer readable medium of claim 12, wherein the program instructions are configured to display the guide map on the monitoring image in response to receiving an operation signal via a user interface.

14. The non-transitory computer readable medium of claim 13, wherein the program instructions are configured to display a captured image of the original image in the first display area when the position of the set area is adjusted, the captured image being the original image at a time when the guide map is activated.

15. The non-transitory computer readable medium of claim 13, wherein the program instructions are configured to remove the guide map from the monitoring image when no operation signal is input for a predetermined period of time or longer.

16. The non-transitory computer readable medium of claim 12, wherein the program instructions are further configure to display, in the first display area, a line that represents a vehicle body line.

17. The non-transitory computer readable medium of claim 11, wherein the program instructions are configured to display an angle of view of at least one of a horizontal direction or a vertical direction in the guide map.

18. The non-transitory computer readable medium of claim 12, wherein the first display area and the second display area have different image properties.

19. The non-transitory computer readable medium of claim 18, wherein the image properties comprise at least one of hue, saturation, brightness, or transparency of image.
